(19) United States
(12) Patent Application Publication
(10) Pub. No.: US 2003/0153233 A1
(43) Pub. Date: Aug. 14, 2003

(54) Front side glass substrate for display and display device

(76) Inventor: Yoshifumi Amano, Kanagawa (JP)

Correspondence Address: William S Frommer, Frommer Lawrence & Haug, 745 Fifth Avenue, New York, NY, 10151, US

(21) Appl. No.: 10/240,378

(22) PCT Filed: Jan. 29, 2002
(86) PCT No.: PCT/JP02/00666

(30) Foreign Application Priority Data
Jan. 29, 2001 (JP) 2001-60904

(51) Int. Cl. H01J 9/02

(52) U.S. Cl. 445/24

(57) ABSTRACT

The present invention is to provide a front glass substrate for a display tube in which a plurality of grooves (2) having similar cross-sections of approximately V-shapes and which also have approximately flat top portions are formed on one surface side of a glass substrate (1) in parallel to each other at a constant interval and in which fluorescent substance layers (3) are deposited on the top portions and the inner wall surfaces of a plurality of groove (2). According to the present invention, the amount in which the fluorescent substances are coated within the grooves can increase. In addition, since light of fluorescent substance can be efficiently radiated to the front surface side from the side surfaces of the grooves in which the coated amount of the fluorescent substances were increased, there can be obtained a front glass substrate for a display tube in which brightness and luminous efficiency can be improved.

### TECHNICAL FIELD

The present invention relates to a front glass substrate for a display tube, a planar discharge display device, a low-speed electron beam type fluorescent display device, a field emission type fluorescent display device, a cathode-ray tube, a discharge luminescent device for illumination, a glass substrate for planar discharge display device, a method of forming electrodes of a planar discharge display device and methods of forming a glass substrate for a planar discharge display device and electrodes of a glass substrate for a planar discharge display device.

### BACKGROUND ART

In planar discharge display devices called a PDP (Plasma Display Panel), although a planar discharge display device including a reflection type fluorescent screen in which fluorescent substances are coated on a rear glass substrate to irradiate ultraviolet rays generated by discharging from electrodes on the front glass substrate to make the fluorescent substances become luminous is a mainstream of such planar discharge display devices, a planar discharge display device having a transmission fluorescent screen in which fluorescent substances are coated on a front glass substrate also is available.

When the planar discharge display device having the reflection type fluorescent screen is compared with the planar discharge display device having the transmission type fluorescent screen, it is said that while the former is wide in light-emission area and high in brightness because fluorescent substances are coated on ribs which form pixels, the latter is inferior to the former from a brightness standpoint.

Accordingly, in a front glass substrate according to the invention (Japanese patent application No. 11-164292) of the prior art proposed by the same applicant and the same inventor of the present invention, as shown in FIG. 1, grooves 2 are directly formed on a front glass substrate 1 by sandblast or chemical etching and fluorescent substances 3 are coated on the inside of the grooves 2. According to this front glass substrate, since the area in which the fluorescent substances are coated can be made twice as large as that of the conventional front glass substrate, brightness could be improved sufficiently.

However, in the front glass substrate having such structure, the cross-sectional shape of the groove considerably affects brightness at which the fluorescent substance coated within the groove can emit light. In the invention according to the prior art, the cross-sectional shape of the groove has not been referred to. As it is usually considered, it has been considered that an amount in which light is emitted from the central portion of the groove seen from the front side, i.e., the top portion which is substantially the flat portion of the groove should preferably be maximized.

Accordingly, in the cross-sectional shape of the groove, as shown in FIG. 2B or 2C, the width (also denoted by reference numeral 14) of the cross-sectional shape of the top portion should be made close to the width (also denoted by reference numeral 12) of the opening portion 12 as much as possible. Alternatively, as shown in FIG. 2B, an inclination angle 16 between the groove and the side surface of the groove adjoining to that groove should preferably be increased.

According to such idea of the prior art, when it is intended to maximize the amount of light emitted from the central portion of the groove, there is a limit on the depth of the groove from a process standpoint so that the area of the side surface of the inner wall of the groove could not be increased. Moreover, when the width of the top portion of the cross-section of the groove is increased, since the inclination angle 16 is decreased inevitably, the amount of light emitted from the side surface of the inner wall of the groove to the front surface is decreased. From the above-mentioned reasons, it has been considered that brightness cannot be increased sufficiently according to the front glass substrate having such structure.

Further, there arose a problem that the front glass substrate with grooves according to the conventional structure is poor in contrast. In order to increase contrast, it is customary that a photoabsorption layer is provided in the front glass substrate at its portion, which is not coated with a fluorescent substance, i.e., the gap portion between the pixels. Specifically, it is customary that such gap portion is made black. However, as is clear from FIG. 1, since the gap portion between the adjacent grooves becomes the deep portion sandwiched by the portions coated with the fluorescent substances when it is seen from the front side, even if this portion is made black, such black portion cannot absorb light from the outside and contrast could not be increased effectively. Since the front glass substrate having this structure can be applied to not only the planar discharge display device but also to a cathode-ray tube (CRT: Cathode Ray Tube) coated with fluorescent substances to emit light, a fluorescent display tube (VFD: Vacuum Fluorescent Display) and the like, there are required similar conditions with respect to the cross-sectional shape of the groove.

Next, a structure of an AC type planar discharge display device (PDP), which is a three-electrode surface discharge type having a conventional reflection type fluorescent screen will be described with reference to FIG. 3. In the AC type planar discharge display device, which is the three-electrode surface discharge type, the following structure members are housed in a tube-assembly in which surrounding portions of a front glass substrate (not shown) and a rear glass substrate 21 are end-sealed by frit glass. At the same time, after the tube-assembly has been evacuated, helium, argon, xenon or a discharge gas (gas) such as mixed gas of these gases is filled into the tube-assembly at pressure of 200 torr to 400 torr.

On the rear glass substrate 21, there are deposited a plurality of address electrodes 27 having the same width which are extended in the longitudinal direction at the same predetermined interval. A dielectric layer 22 is deposited on the rear glass substrate 27 and a plurality of address electrodes 27 by printing of a suitable material such as low-melting glass. On the rear glass substrate 21, there are deposited a plurality of ribs which are extended in parallel to each other, i.e., a plurality of ribs 23 over the dielectric layer 22 so as to sandwich a plurality of address electrodes 27. A fluorescent substance 24 is coated on the inner wall of the groove comprised of the wall surfaces of the ribs 23 and the surface of the dielectric layer 22 on the address electrode 27.

Then, on the front glass substrate, which is not shown in FIG. 3, there are deposited sustain electrodes (display electrodes) 28, 29 as a plurality of sets of pairs of flat-plate like discharge electrodes of the same width which are parallel to each other and close to each other in such a manner that they become substantially perpendicular to a plurality of address electrodes 27 and a plurality of ribs 23 of the rear glass substrates 21. A plurality of electrodes of one of each set of a pair of sustain electrodes 28, 29 forms an XY matrix with a plurality of address electrodes 27. A dielectric layer 25 is deposited on the front glass substrate and a plurality of pairs of sustains electrodes 28, 29 so as cover them. The dielectric layer 25 is formed on a plurality of sets of sustain electrodes 28, 29 so as to have a uniform thickness without being separated at every pixel. Further, the surface of the dielectric layer 25 is covered with a protective layer 26 such as Mgo.

The dielectric layer 25 which covers a plurality of sets of sustain electrodes 28, 29 of the planar discharge display device having such structure is formed on the surface of the electrode which can operate as a discharge electrode so as to have a uniform thickness.

In the planar discharge display device, since sustain electrodes for main discharging are disposed on the front glass substrate, the sustain electrodes should be made transparent so as not to disturb radiation of light from the fluorescent screen to the front surface.

Moreover, transmission planar discharge display device having a structure in which the front side and the rear side of the planar discharge display device shown in FIG. 3 are reversed and which includes a fluorescent screen on the front glass substrate are partly commercially available.

In the patent applications (Japanese patent application No. 11-80235 and Japanese patent application No. 11-164292, etc.) that have been filed by the same applicant and the same inventor of the present application, there are proposed transmission type planar discharge display devices in which discharge spaces are formed by forming grooves on a glass substrate and are used as front glass substrates.

In the conventional planar discharge display device shown in FIG. 3, since the sustain electrodes 28, 29 on the front glass substrate should be made nearly transparent, there arises a problem from a process standpoint. Moreover, it takes a lot of time to form ribs, which is also a problem from a process standpoint.

On the other hand, although it has been attempted to directly form the grooves on the glass substrate to form discharge spaces by sandblast or chemical etching, since there is no proper method of forming electrodes within the grooves thus formed, address electrodes cannot be formed according to the arrangement of the electrodes of the conventional planar discharge display device of the three-electrode surface discharge type.

The present invention is to provide a front glass substrate for a display tube and a planar discharge display device in which an amount of fluorescent substances coated on the inside of the groove can be increased, the fluorescent substances can radiate light from the side surface of the inner wall of the groove to the front surface efficiently and in which brightness and luminous efficiency can be improved.

Furthermore, the present invention is to provide a front glass substrate for a display tube and a planar discharge display device in which brightness and contrast can be improved.

### DISCLOSURE OF INVENTION

The present invention is a front glass substrate for a display tube in which a plurality of grooves having same cross-sections of substantially V-like shapes and which have substantially flat top portions are formed on one surface side of a glass substrate in parallel to each other at a constant interval and in which fluorescent substance layers are deposited on the top portions of a plurality of grooves and the inner wall surfaces.

The present invention is a front glass substrate for display tube in which cross-sectional shapes of substantially V-like shapes and which have substantially flat top portions are formed on one surface side of a glass substrate in parallel to each other at a constant interval, fluorescent substance layers are deposited on the top portions of a plurality of grooves and the inner wall surfaces, widths of substantially flat top portions are made less than half of widths of opening portions, heights from the opening portions to the top portions are larger than the widths of the opening portions and a gap width between the opening portions of the adjacent grooves is made smaller than half of the width of the opening portion of the groove.

The present invention is a glass substrate for a planar discharge display device in which a plurality of grooves having same cross-sections of substantially V-like shapes are formed on one surface side of a glass substrate in parallel to each other at a constant interval, electrode layers are deposited on the top portions of a plurality of grooves and fluorescent substance layers are deposited on the inner wall surfaces of a plurality of grooves and the electrode layers.

The present invention is a method of forming electrodes of a glass substrate for a planar discharge display device in which reservoirs of paste-like conductive inks are formed on top portions of a plurality of grooves by coating paste-like conductive inks on a plurality of grooves having same cross-sections of substantially V-like shapes formed on one surface of a glass substrate in parallel to each other at a constant interval, paste-like inks with a plurality of grooves are dried, stripe-like conductive inks are left on the top portions of a plurality of grooves by removing conductive inks from the inner wall surfaces of a plurality of grooves are removed according to sandblasting of the glass substrate and electrodes are formed by sintering the remaining stripe-like conductive inks.

### BRIEF DESCRIPTION OF DRAWINGS

FIG. 1 is a perspective view showing a part of a front glass substrate according to the prior art.

FIG. 2 are fragmentary cross-sectional views of various kinds of glass substrates used to compare cross-sectional shapes of grooves formed on glass substrates.

FIG. 3 is a fragmentary exploded perspective view of a planar discharge display device (PDP) of a three-electrode surface emission type including a conventional reflective type fluorescent screen.

FIG. 4 is a perspective view showing a part of a front glass substrate according to an embodiment of the present invention.

FIG. 5 is an enlarged cross-sectional view showing a part of a front glass substrate according to an embodiment of the present invention.

FIG. 6 is an enlarged cross-sectional view showing a part of a front glass substrate according to an embodiment of the present invention.

FIG. 7 is a cross-sectional view showing a part of a front glass substrate according to other embodiment of the present invention.

FIG. 8 is a cross-sectional view showing a part of a front glass substrate according to other embodiment of the present invention.

FIG. 9 is a cross-sectional view showing a part of a front glass substrate according to other embodiment of the present invention.

FIG. 10 is an enlarged perspective view showing apart of a planar discharge display device (PDP) according to an embodiment of the present invention.

FIG. 11 is a fragmentary exploded cross-sectional view of a field emission type fluorescent display device according to an embodiment of the present invention.

FIG. 12 is a cross-sectional view showing a part of a cathode-ray tube according to an embodiment of the present invention.

FIG. 13 is an exploded perspective view showing a part of an arc tube according to an embodiment of the present invention.

FIG. 14 is a cross-sectional view showing a part of a glass substrate for use with a planar discharge display device according to an embodiment of thepresent invention.

FIG. 15 are cross-sectional process diagrams showing a method of forming a glass substrate for use with a planar discharge display device according to an embodiment of thepresent invention.

FIG. 16 is across-sectional view showing a part of a glass substrate for use with a planar discharge display device according to other embodiment of the present invention.

FIG. 17 are cross-sectional process diagrams showing a method of forming a glass substrate for use with a planar discharge display device according to other embodiment of the present invention.

FIG. 18 is an exploded perspective view showing a part of a planar discharge display device (PDP) according to other embodiment of the present invention.

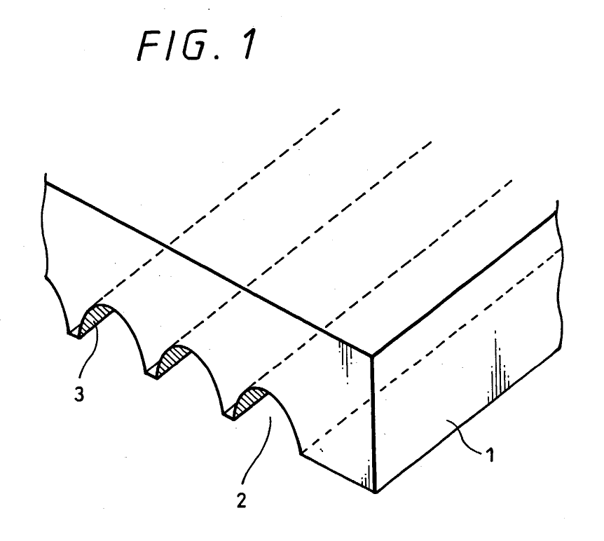

### BEST MODE FOR CARRYING OUT THE INVENTION

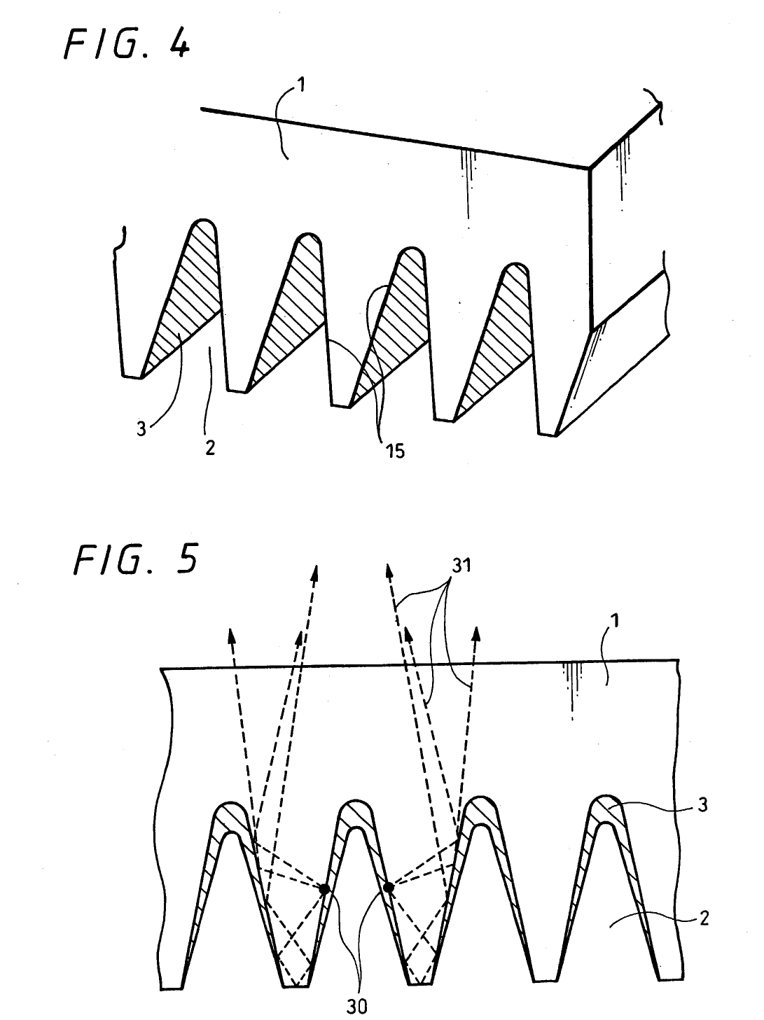

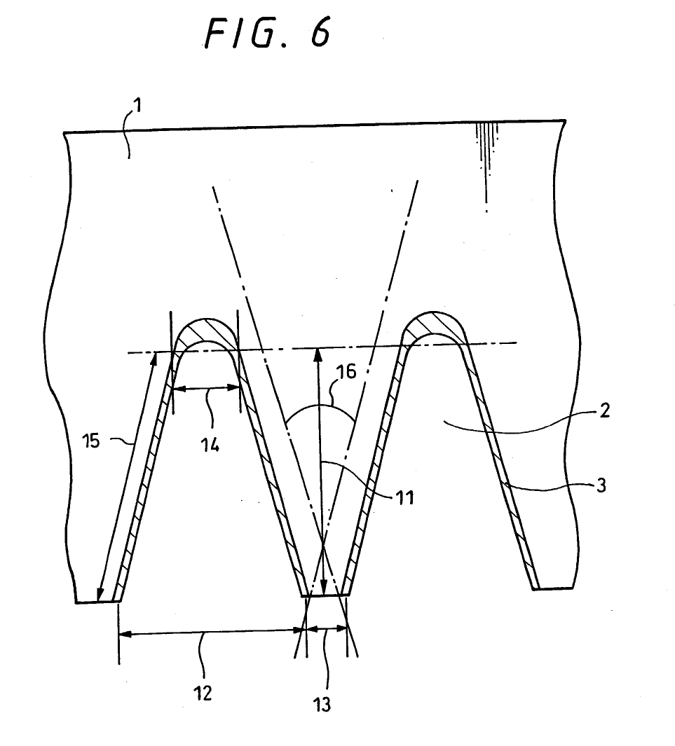

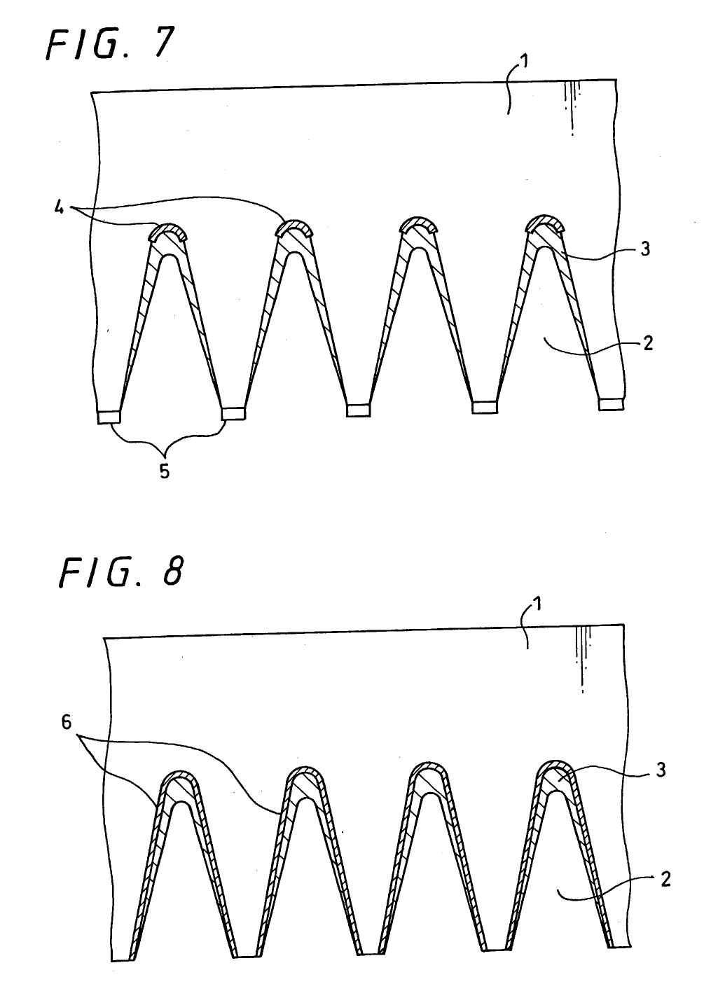

First, an arrangement of a front glass substrate for use with a display device according to an embodiment of the present invention will be described with reference to FIGS. 4, 5 and 6. FIGS. 4 and 5 are a perspective view and a cross-sectional view of a part of the front glass substrate, respectively. FIG. 5 shows the manner in which light is emitted in the front glass substrate. FIG. 6 is an enlarged cross-sectional view showing a part of FIG. 5.

Referring to FIG. 4, on a transparent front glass substrate 1, there are formed a plurality of grooves 2 having similar cross-sectional shapes at a constant interval in parallel to each other. A fluorescent substance 3 is coated on the inner wall surfaces of a plurality of grooves 2. The fluorescent substance 3 is energized to emit light by ultraviolet rays generated by discharging of discharge electrodes provided on a rear glass substrate, not shown, or electron beams from an electron gun. Since the front glass substrate 1 is transparent, light emitted from the fluorescent substance 3 is irradiated on the viewing side, i.e., the front side of the front glass substrate 1.

The cross-sectional shape of the groove 2 of the front glass substrate 1 shown in FIG. 4 can be freely changed as an arc shape, a shape close to a square, a V-like shape, a U-like shape and the like.

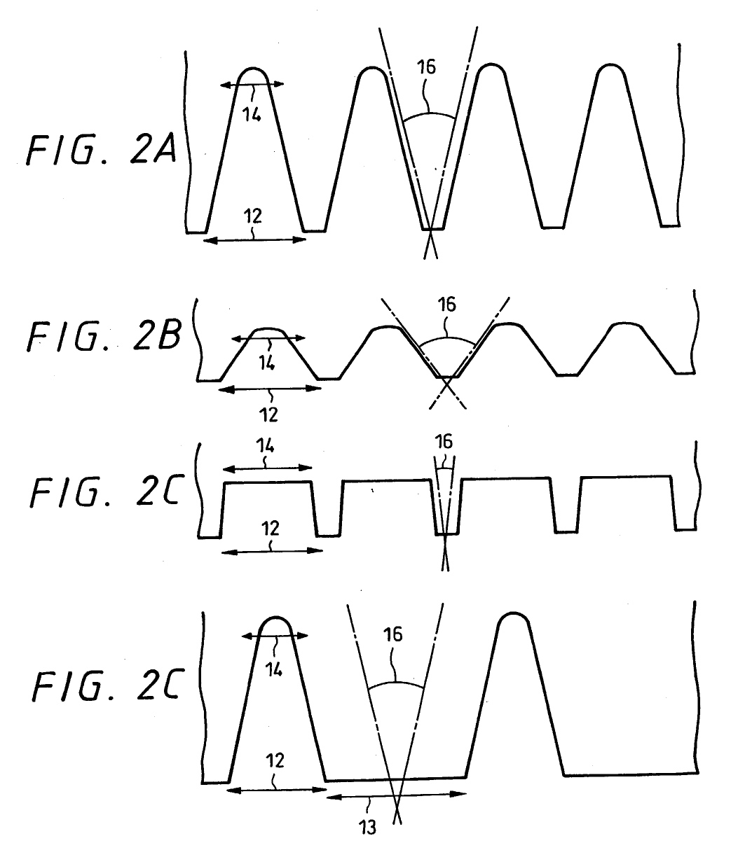

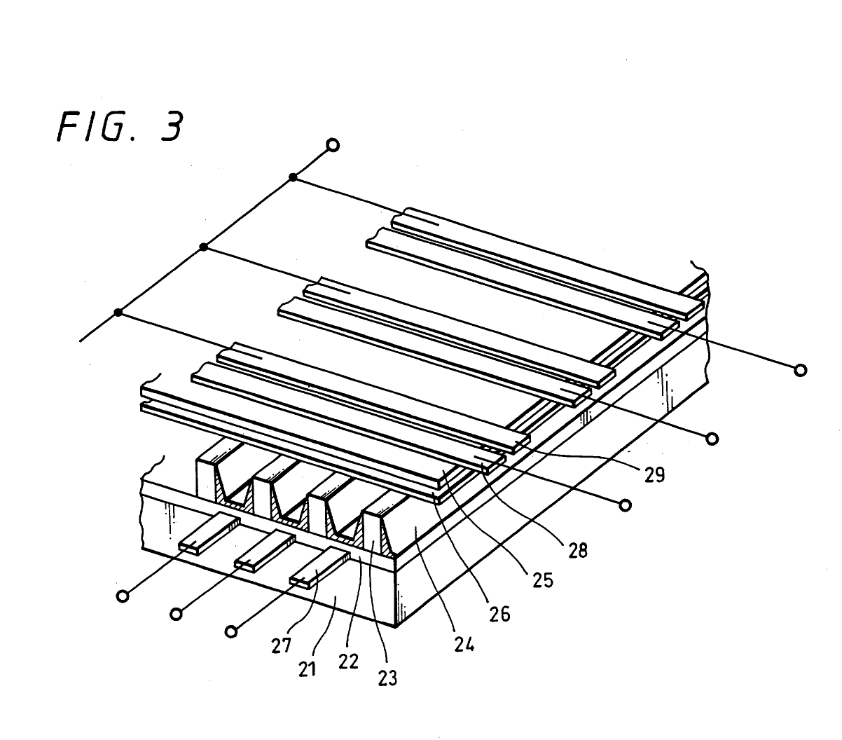

The state of light emitted from the fluorescent substance 3 coated within the groove 2, which has any one of these cross-sectional shapes, will be described with reference to FIGS. 5 and 6. As shown in FIGS. 5 and 6, when an inclination angle 16 of the wall surface at a light emission point is small, the amount in which light emitted from the light emission point 30 within in the inner wall surface of the groove 2 is irradiated toward the wall surface of the adjacent groove 2 is larger than the amount in which light is directly irradiated on the front surface, i.e., on the upper portion of FIG. 2.

Light which becomes incident on the wall surface of the adjacent groove 2 is separated into light which is upwardly reflected on the interface of glass, light which is refracted and introduced into the inside of the adjacent groove 2, i.e., toward the outside of the glass and light which is downwardly reflected and irradiated on the front after it has been reflected repeatedly several times. To form the groove 2 which can satisfy these conditions, not only the cross-sectional shape of the groove 2 but also a distance between it and the adjacent groove 2 become important. To study the conditions of the cross-sectional shape, the cross-sectional shape of the groove will be described with reference to FIG. 6 and FIG. 2.

First, in order to limit light directly radiated from the top portion of the groove 2 to the front, a width (denoted by the similar reference numeral 14) of the top portion 14 is reduced as compared with a width (denoted by the similar reference numeral 12) of the bottom opening portion 12, whereby the cross-sectional shape of the groove 2 is made close to V-like shape. The cross-section of the side wall surface of the groove 2 need not always be made linear but may be such one that the width of the cross-section of the groove 2 is progressively and smoothly reduced from the bottom opening portion 12 to the top portion 14. Chemical etching or sandblast can form the groove 2 of such shape more easily.

An angle (inclination angle) 16 between the side wall surface of the groove and the side wall surface of the groove adjacent to such groove is set within a range of constant angles and the distance 13 between the bottom opening portions of the bottoms of the adjacent grooves should preferably be reduced.

The above-mentioned relationship will become clearer with reference to FIG. 2. Specifically, FIG. 2A shows a cross-sectional shape of a groove of an example of a front glass substrate according to the present invention, and FIGS. 2B, 2C and 2D show examples of cross-sectional shapes of grooves of a front glass substrates according to the prior art, which are examples of cross-sectional shapes that had been formed at random. So far it has been considered that the cross-sectional shape of the groove shown in FIG. 2B or 2C is a suitable cross-sectional shape of groove. In this case, light from the side surface of the groove is hardly radiated toward the front side. Moreover, since the distance 13 between the opening portions of the bottom portions of the groove obtained in the case of FIG. 2D is long, light from the sidewall surface of the groove can be prevented from being reflected on the sidewall surface of the adjacent groove.

In the condition under which most of light irradiated from the side wall surface of the groove to the side wall surface of the adjacent groove may be totally reflected to the front in the groove shown in FIG. 2A which shows one of examples of grooves which can satisfy the above-mentioned necessary conditions, considering that a refractive index of ordinary glass is approximately 1.5, the inclination angle 16 is beyond approximately 45 degrees when the width 13 between it and the adjacent groove is zero. However, when the inclination angle 16 exceeds 90 degrees, it is natural that light should not be irradiated on the inner wall surface of the adjacent groove. Moreover, since the gap 13 is about one half of the bottom opening portion 12, the inclination angle also should be slightly smaller than the above-mentioned angle of approximately 45 degrees. Accordingly, the inclination angle 16 may be suitably selected between 30 degrees and 90 degrees, for example.

When the groove having such cross-sectional shape and such distance between it and the adjacent distance is formed on the glass substrate, since the angle of the wall surface of the groove is difficult to control from a process standpoint, the conditions should preferably be prescribed. To satisfy the above-mentioned conditions, if the grooves should have cross-sectional shapes such that grooves should be V-like shape whose width is linearly reduced from the bottom opening portion 12 of the groove 2 toward the upward approximately flat top portion 14 or grooves should be U-like shape whose width is reduced like a gentle curve and in which the width of the bottom portion is less than one half of the bottom opening portion 12, the height from the bottom opening portion 12 to the top portion 12, i.e., the groove depth 11 is larger than the bottom opening portion 12 and the gap width 13 between the adjacent grooves 2 is smaller than on half of the width 12 of the bottom opening portion 12, light from the fluorescent screen can be effectively irradiated on the front side while reflection on the wall surface of the adjacent groove is being utilized at maximum.

Next, an arrangement of a front glass substrate for a display device according to other embodiment of the present invention will be described with reference to FIG. 7. First, let it be assumed that the shape of the groove 2 satisfies the conditions of the examples of the front glass substrate for a display device shown in FIGS. 4 and 6. The front glass substrate for a display device shown in FIG. 7 is characterized in that a light absorption layer 4 such as black color is formed on the glass surface of the top portion 12 of the groove 2 and that a light reflection layer 5 such as white color is formed on the glass surface of the gap between the adjacent grooves 2 and 2.

The light absorption layer 4 can be easily formed by a method in which black paint is coated and settled on the layer by a solvent. When the inner wall surface of the respective grooves 2 are painted with the fluorescent substances 3 of proper luminous colors such as red, green, blue, for example, color filters are formed by coating paints of colors corresponding to the fluorescent substances 3 on the inner wall surfaces of the grooves 2 in advance. In that case, color filters can be formed as the light absorption layer 4 by coating paints of respective colors of larger amounts on the top portion while concentrations at which paints are coated are being adjusted.

The light reflection layer 5 may be formed by coating a proper paint such as a white paint on the glass surface of the gap between the adjacent grooves 2 in accordance with screen-printing. The fluorescent substance layer 3 is coated on the inner wall surface of the groove 2 by screen-printing after the paint layer, the light absorption layer 4 and the light reflection layer 5 have been formed. The structures of the front glass substrates 1 shown in FIG. 4 to FIGS. 6 and 7 are suitably applied to the front glass substrate comprising the flat tube-assembly of the planar discharge display device, which is a gas discharge tube.

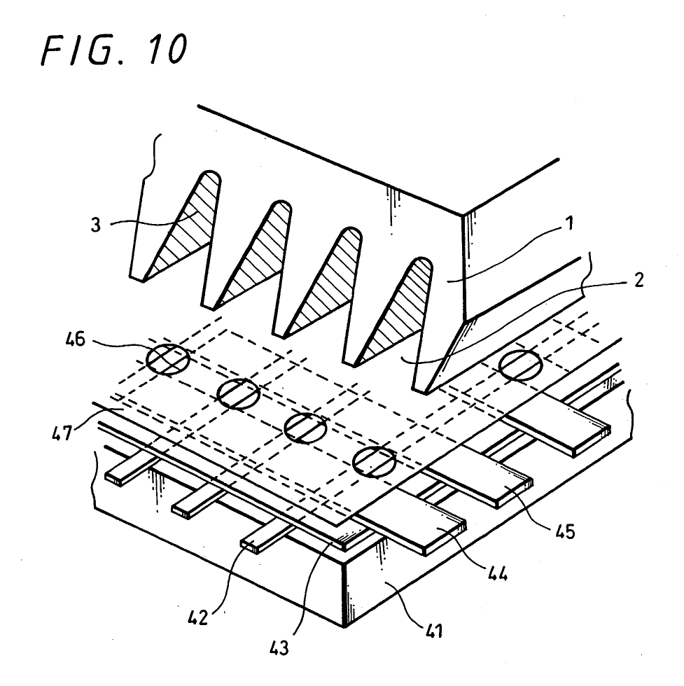

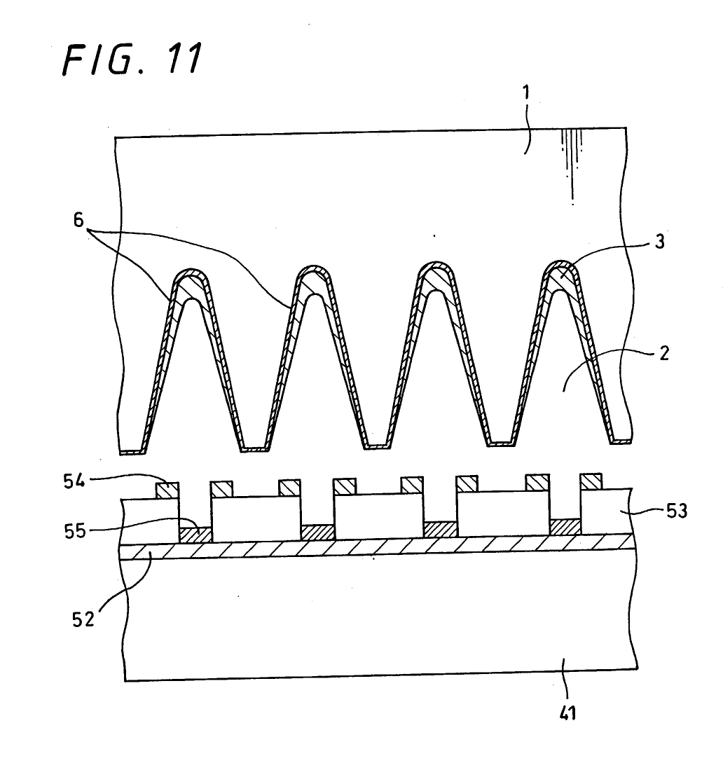

FIG. 10 is an exploded perspective view showing a planar discharge display device according to an embodiment of the present invention to which the above front glass substrate is applied. The structure of this planar discharge display device will be described below. This planar discharge display device is such one in which the above-mentioned front glass substrate is applied to a planar discharge display device of a patent application (Japanese patent application No. 2000-131820) that has been previously proposed by the same assignee and the same inventor of the present invention.

In FIG. 10, reference numeral 1 denotes a front glass substrate. This front glass substrate 1 includes a plurality of grooves 2 having the same cross-sectional shape with fluorescent substances 3 coated on their inner wall surfaces and which are formed in parallel to each other at a constant interval. Since the grooves 2 are formed on this front glass substrate 1, electrodes cannot be formed on the front glass substrate 1. For this reason, necessary electrodes maybe formed on the side of a rear glass substrate 41 as multiplayer-electrodes.

As shown in FIG. 10, a plurality of address electrodes 42 with the same width are formed on the rear glass substrate 41 at a constant interval in parallel to each other. This planar discharge display device further includes a plurality of sustain electrodes 44 and 45 which are alternately disposed so as to oppose or cross a plurality of address electrodes 42 through an insulating layer 43 to form an XY matrix for effecting display discharging. As the structures which featuring this planar discharge display device, there are through-holes 46.

The through-holes 46 are effective means for enabling address discharge to occur easily. These sustain electrodes 44 and 45 are covered with an upper dielectric layer 47. Accordingly, this planar discharge display device is a three-electrode AC type planar discharge display device of a so-called single substrate type. Then, ultraviolet rays generated by discharge between the sustain electrodes 44 and 45 are efficiently irradiated on the fluorescent substance layers 3 which are respectively formed on the inner wall surfaces of a plurality of grooves 2 of the front glass substrate 1. Light beams emitted from the respective fluorescent substances 3 are reflected on the wall surface of the adjacent groove 2 and are efficiently irradiated on the front side with a certain extent of directivity.

Next, an arrangement of a front glass substrate for a display device according to another embodiment of the present invention will be described with reference to FIG. 8. First, the shape of the groove 2 may satisfy the conditions of the front glass substrate shown in FIGS. 4 to 6. The front glass substrate 1 shown in FIG. 8 is suitably applied to a front glass substrate of a low-speed electron beam fluorescent display device (VFD: Vacuum Fluorescent Display) or a front glass substrate of an electron beam type display device called a field emission fluorescent display device (FED: Field Emission Display) having a field emission type cathode rather than the planar discharge display device (PDP).

Referring to FIG. 8, a transparent conductive film 6 is deposited on the inner wall surface of the front glass substrate 1. This transparent conductive film 6 can be easily formed by vacuum-evaporating a suitable material such as indium silver oxide on the inner wall surface of the groove 2. This transparent conductive layer 6 is an electrode for accelerating electrons with application of an anode potential to the fluorescent substance layer 3 having conductivity.

FIG. 11 shows a field emission type fluorescent display device (FED) according to an embodiment of the present invention to which the front glass substrate 1 shown in FIG. 8 is applied. A structure of this display device will be described below. A plurality of electrodes 52 are formed on a rear glass substrate 41 on which there are provided a plurality of second electrodes 54 which cross a plurality of first electrodes 52 through insulating layers 53 to thereby form an XY matrix. These first and second electrodes 52 and 54 are designed to cross to each other through through-holes. On the first electrodes 52, there are mounted cathode layers 55, i.e., field emission type acicular cathode layers, carbon layers and the like, for example. Then, electrons are emitted from the cathode layers 55 with application of a voltage to these electrodes 52 and 54. Electrons thus emitted are accelerated by a voltage applied to the electrode 6 of the inner wall surface of the groove 2 of the front glass substrate 1 and are irradiated on the fluorescent screen 3 on the electrode 6 to make the fluorescent screen 3 become luminous. Light from the fluorescent screen 3 of a certain groove 2 is reflected on the wall surface of the groove 2 adjoining to a certain groove 2 and is efficiently irradiated on the front surface with a certain degree of directivity.

Next, a front glass substrate according to another embodiment of the present invention will be described with reference to FTG. 9. The groove 2 formed on this front glass substrate 1 can satisfy the conditions of the groove 2 of the front glass substrate 1 shown in FIGS. 4 to 6. The front glass substrate 1 having this structure is suitable as an application to a high-speed electron beam type fluorescent display device, i.e., a cathode-ray tube (CRT) or an electron beam type display device called a field emission fluorescent display device having a field emission type cathode.

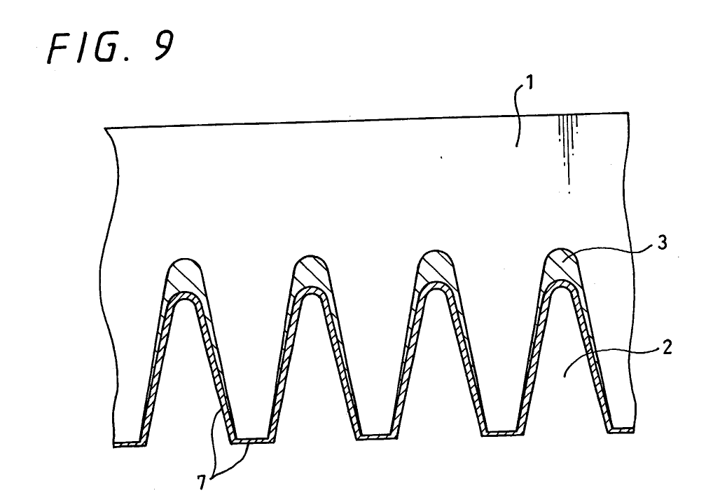

Referring to FIG. 9, fluorescent substances 3 are coated on the inner wall surfaces of a plurality of grooves 2 of the front glass substrate 1, and conductive films, i. e., metal films 7 are coated so as to cover the surfaces of the fluorescent substances 3. The metal film 7 need not always be made of a transparent material but may be generally made of an aluminum film by vapor-deposition. This metal film is referred to as a metal-back layer in a cathode-ray tube (CRT). This metal film is effective for not only applying an anode potential to the electrodes to thereby accelerate electrons but also for reflecting light emitted from the fluorescent substance 3 to the inside of the tube.

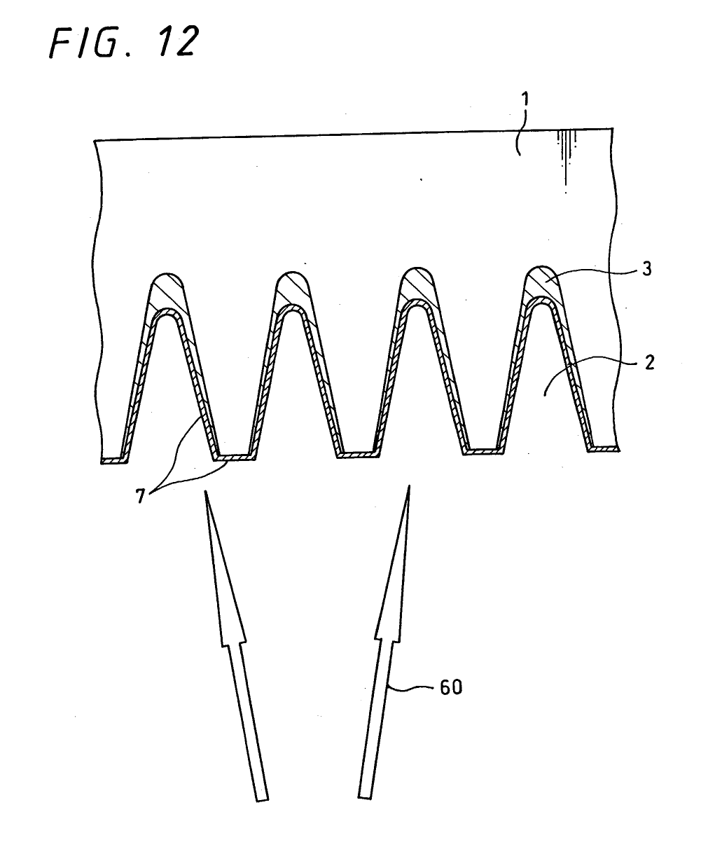

FIG. 12 is a conceptual diagram showing a part of a cathode-ray tube according to an embodiment of the present invention to which the front glass substrate shown in FIG. 9 is applied. Although other arrangements of the cathode-ray tube are not shown, a metal plate such as a shadow mask or an aperture grill having color selection function is provided on the rear side of the groove 2 of the front glass substrate, i.e., within the tube of the cathode-ray tube (CRT). This cathode-ray tube includes an electron gun for generating electron beams 60 and a beam deflection mechanism such as a deflection yoke similarly to ordinary cathode-ray tubes.

The front glass substrate 1 may of course be combined with such one having a structure in which the light absorption layer 4 that has been described so far with reference to FIG. 7 is added. As the field emission type fluorescent display device (FED) including the above-mentioned field emission type cathode, there is available a high-speed electron beam type display device similar to the cathode-ray tube (CRT). In that case, the front glass substrate that has been described so far with reference to FIG. 9 is suitable for use with such high-speed electron beam type display device.

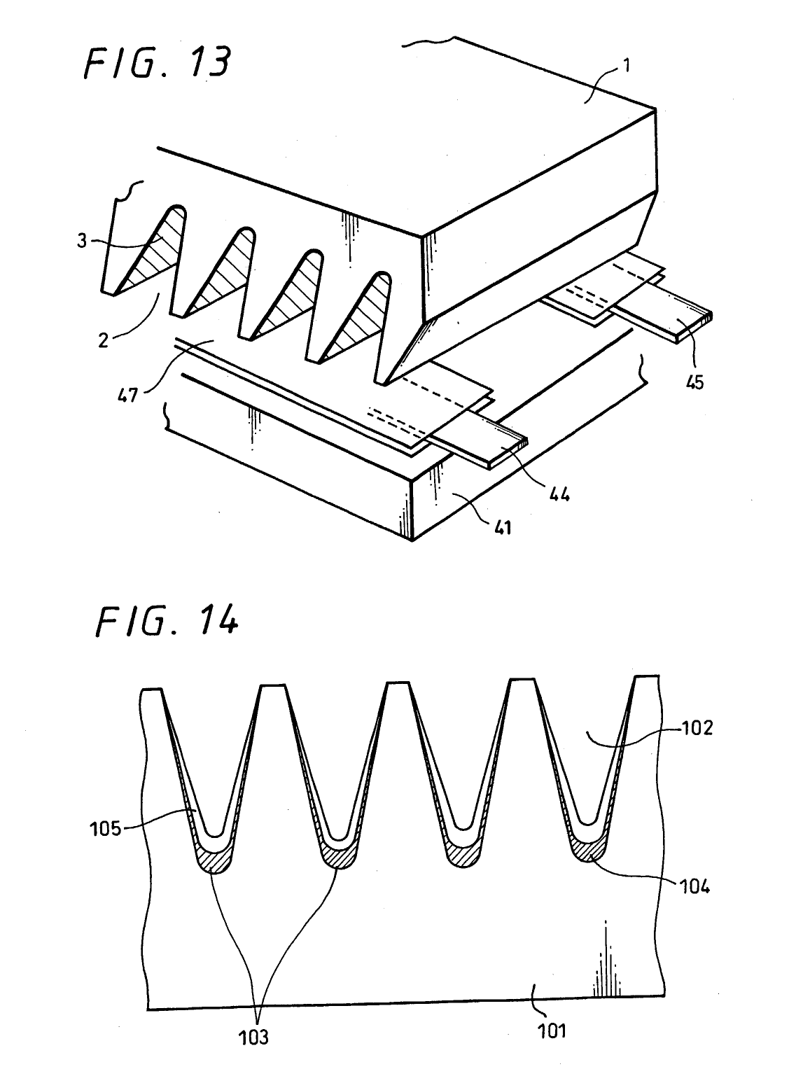

Next, a structure of a luminous tube to which the front glass substrate that has been described so far with reference to FIGS. 4 to 6 is applied will be described with reference to FIG. 13. A structure of a luminous tube is very similar to the structure of the planar discharge display device (PDP) that has been described so far with reference to FIG. 10. A pair of discharge electrodes (sustain electrodes) 44, 45 are located at respective sides of the groove 2 of the front glass substrate 1. It is sufficient that a pair of sustain electrodes may be provided. In this case, since the luminous tube need not separate pixels, the front glass substrate 1 and the rear glass substrate 41 need not be brought in contact with each other. When the two glass substrates are slightly spaced apart from each other, luminous efficiency can be increased.

While an AC type discharge electrode similar to the planar discharge display device (PDP) is formed by respectively coating the pair of sustain electrodes 44, 45 with the upper dielectric layer 47 in FIG. 13, a discharge light emission device for illumination may be comprised by using the pair of sustain electrodes 44, 45 or by using a pair of coil-like hot cathodes instead of the sustain electrodes.

An arrangement of a glass substrate for a planar discharge display device according to an embodiment of the present invention will be described below with reference to FIG. 14. FIG. 14 shows across-sectional view of such glass substrate. Reference numeral 101 denotes a glass substrate. On the glass substrate 101, there are formed a plurality of parallel grooves 102 having cross-sections of V-like shapes by sandblast or chemical etching. In this case, an opening width and a depth of the groove 102 are set to be approximately the same, for example. Then, when the depth of the groove 102 is larger than the opening width (V-like groove), sandblast is suitable for forming the groove 102. When the depth of the groove 102 is smaller than the opening width (U-like groove), either sandblast or chemical etching may form the grooves.

Electrodes 104 are formed on top portions 103 of a plurality of grooves 102 thus formed. A method of forming the electrodes 104 will be described later on. After the electrodes 104 had been formed, fluorescent substance layers 105 are formed in the inside of the grooves 102, i.e., on the inner wall surfaces of the grooves 102 and on the electrodes 104. Although not shown in FIG. 14, electrodes can be formed as so-called AC type electrodes by coating the electrodes 104 with dielectric layers.

The glass substrate 101 shown in FIG. 14 can be applied to both of the front glass substrate and the rear glass substrate of the planar discharge display device. A structure of a planar discharge display device obtained when the above glass substrate is used as the front glass substrate will be described later on. When the glass substrate 101 shown in FIG. 14 is used as the rear glass substrate, prior to forming the fluorescent substance layers 105, light reflection layers such as white may be formed on the inner wall surfaces of the grooves 102.

When the glass substrate shown in FIG. 14 is used as the front glass substrate of the planar discharge display device, the fluorescent substance layers 105 coated on the wall surfaces of the grooves 102 are excited to emit light by ultraviolet rays generated by discharging in the sustain electrodes on the opposing rear glass substrate. The emitted light is passed through the glass substrate 101 and is directly radiated onto the front side. At the same time, this light is reflected on the wall surface of the adjacent groove 102 and thereby radiated onto the front side.

In FIG. 14, when the depth of the groove 102 is larger than the width of the opening portion of the groove 102, since the cross-sectional shape of the groove 102 becomes V-like shape and the area of the inner wall surface of the groove 102 is increased as described above, an amount of light emitted from the fluorescent substance 3 can be increased. However, since the cross-sectional shape is the V-like shape, the fluorescent substance layer 105 on the electrode 104 of the top portion 103 is located far away from a discharge portion serving as an ultraviolet source. As a result, luminous efficiency is low and most of emitted light is irradiated on the wall surfaces of the grooves 102 at both sides from the wall surface of the groove 102, reflected thereon and radiated onto the front surface. Accordingly, even when the electrode 104 is provided on the top portion 103 of the groove 102, this can hardly affect the amount of emitted light. When this electrode 104 is made black, light from the outside can be absorbed and contrast can be improved.

Accordingly, when the cross-sectional shape of the groove 102 is V-like shape, not only the area of the fluorescent substance of the wall surface of the groove 102 is increased but also this cross-sectional shape is suitable for efficiently radiating emitted light toward the front side. Thus, both of brightness and contrast of the planar discharge display device can be increased.

When the glass substrate 101 having the structure shown in FIG. 14 is applied to the rear glass substrate, the display device can operate similarly to the conventional planar discharge display device including the reflection type fluorescent screen and the process for forming the ribs can be simplified considerably.

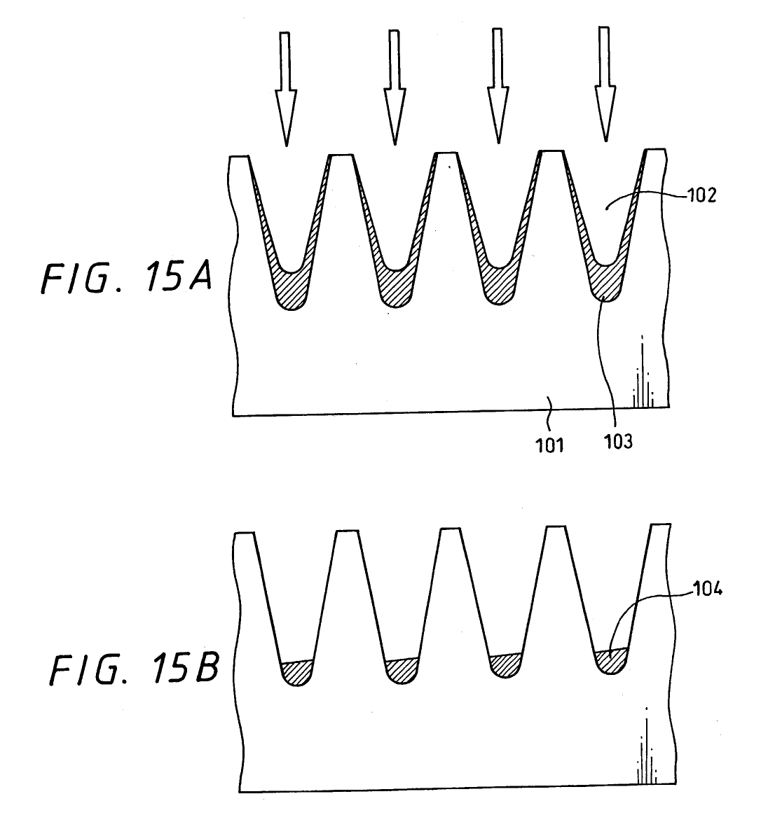

Next, a method of forming the electrode layer 104 in the inside of the groove of the glass substrate according to an embodiment of the present invention will be described with reference to FIG. 15. Although a method of forming the groove 102 on the glass substrate 101 will not be described, sandblasting is generally suitable for such method.

As shown in FIG. 15, conductive paste ink, e.g., screen-printing paste such as silver or nickel is filled into the V-like groove 102 and is temporarily dried. Although the screen-printing paste may be filled into the groove so as to be coated on the whole inner wall surface of the groove 102, the screen-printing is suitable for increasing uniformity more. When the screen-printing paste is dried, as shown in FIG. 15A, although the paste is attached to the whole wall surface of the groove 102, since the cross-section of the groove is of the V-like shape, reservoirs of pastes are formed on the top portions 103. Accordingly, when the wall surface of the groove 102 is removed by sandblast, only the portions of the paste reservoirs are left.

When the pastes left in the groove 102 are sintered, as shown in FIG. 15B, the electrode layers 104 can be formed within the grooves 102.

Since the dried conductive pastes are easily removed by sandblast as compared with the plate glass, the electrode 104 can be formed as the shape shown in FIG. 15B extremely easily.

As described above, by effectively utilizing the fact that the groove 102 is of the V-like shape, the reservoirs of pastes can be formed on the top portions 103. When the pastes on the wall surface of the grooves 102 except the pastes on the top portions 103 of the grooves 102 are removed by sandblast, only the conductive pastes can be easily removed by effectively utilizing a difference between hardness of conductive pastes obtained before sintering after they had been dried and hardness of the plate glass without using a selective mask pattern.

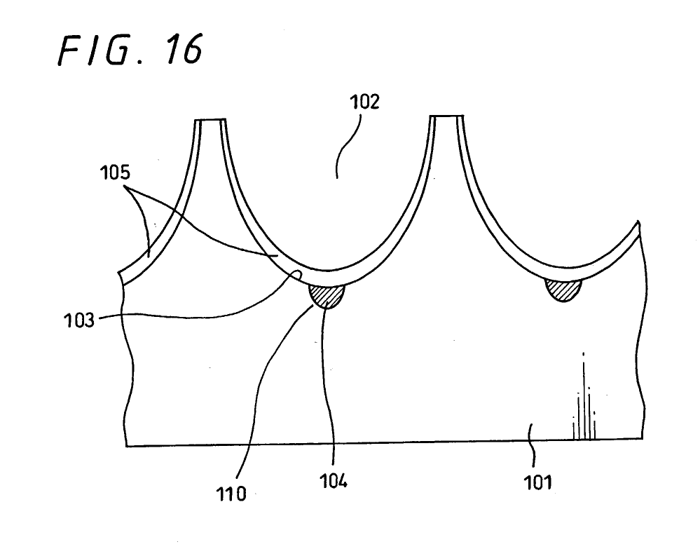

Next, a structure of a glass substrate for a planar discharge display device according to an embodiment of the present invention will be described with reference to FIG. 16. First, the grooves 102 having U-like cross-sectional shapes are formed on the glass substrate 1 by sandblast or chemical etching. As described above, when the depth of the groove 102 is relatively smaller than the opening width of the groove 102, the grooves 102 can be easily formed by either sandblast or chemical etching. In this case, since the top portion 103 is nearly flat as compared with the groove 102 having the cross-section of V-like shape shown in FIG. 15, a second groove 110 is formed on the top portion as a narrow groove that is used to form an electrode. Thereafter, conductive ink pastes are filled into the second groove 110 and the electrode layer 104 is formed by a method similar to the above-mentioned method. In order to efficiently irradiate ultraviolet rays, generated by gas discharging, onto the fluorescent substance 105, when the groove 102 has the cross-section of the V-like shape, the opening width of the groove may lie in a range of from approximately 100 to 200 μm and then depth of the groove may lie in a range of from approximately 100 to 200 μm. When the groove has an opening width larger than the above-mentioned opening width and a comparatively large pixel is formed, effects achieved when the groove 102 has the cross-section of V-like shape are decreased and the groove having the cross-section of U-like shape is suitable for forming the electrode.

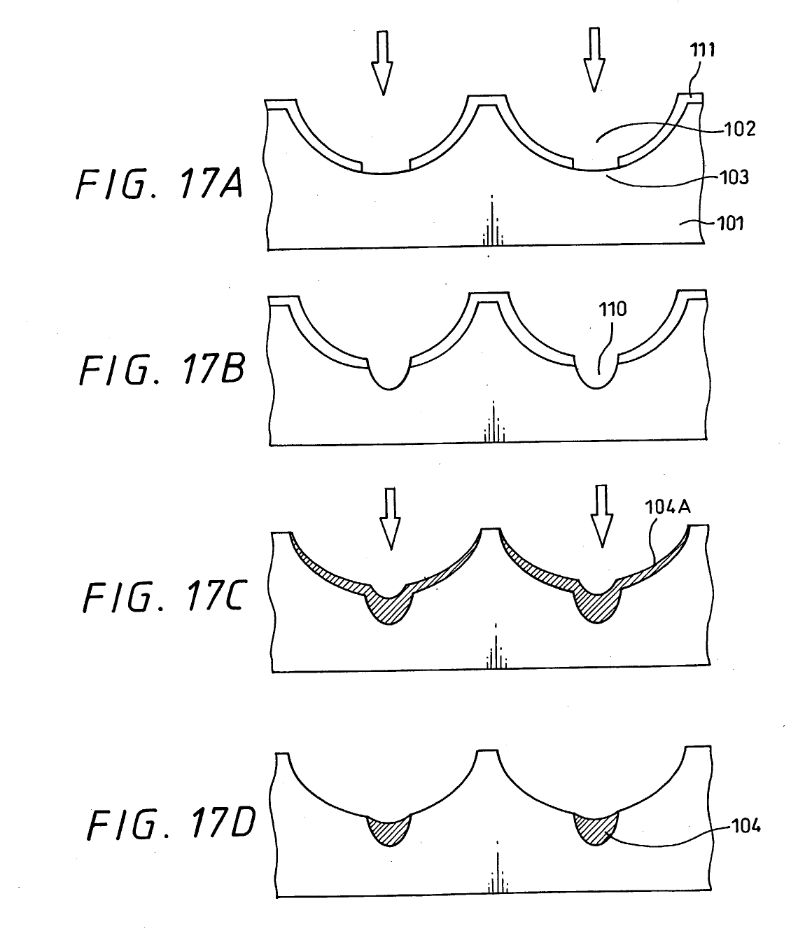

Next, a method of manufacturing a glass substrate for planar discharge display device that has been described so far with reference to FIG. 16 will be described with reference to FIG. 17. A method of forming the glass substrate according to the embodiment will be described with reference to FIG. 17A. The grooves 102 having the cross-section of U-like shape are formed on the glass substrate 101 shown in FIG. 17A by a suitable method such as sandblast or chemical etching.

First, a mask 111 made of resin having excellent anti-sandblast property or excellent anti-solvent property is printed on the inner wall surface of the groove 102 by screen-printing in such a manner that it may cover the inner wall surface of the groove 102. The printing pattern in this case is made coincident with the pattern of the wall surface portion of the groove 102, and the printed resin mask 111 is printed such that the top portion 3 of the groove 102 may be dropped out in a stripe fashion.

Thereafter, when the inside of this groove 102 is treated by sandblast or chemical etching, due to the existence of the resin mask 111, the second groove 110 is formed on the top portion 103 of the groove 102.

Then, as shown in FIG. 17C, when the conductive ink paste 104A is filled into the second groove 102 and dried and the ink paste 104A is removed from the inner wall surface except the portion of the second groove 110 by sandblast similarly as described above, as shown in FIG. 17D, the electrode layer 104 is formed within the second groove 110.

As described above, the second groove 110 can be formed on the top portion 103 of the groove 102 having the cross-section of U-like shape and the electrode layer 104 with the narrow width can be formed within the second groove with ease.

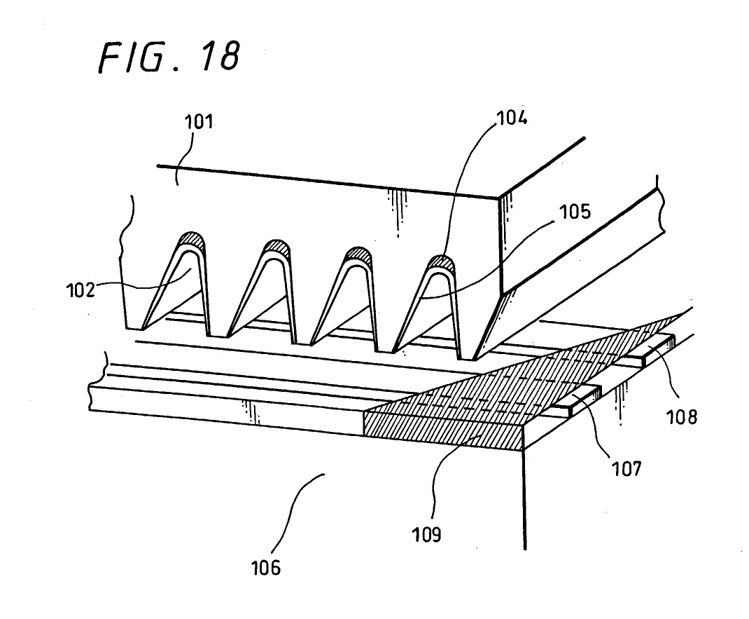

Next, a structure of an example of an AC type planar discharge display device using the glass substrate 101 in which the groove 102 having the V-like cross-sectional shape was formed will be described with reference to an exploded perspective view of FIG. 18. This example is the case in which the glass substrate 101 shown in FIG. 14 is used as the front glass substrate.

This AC type planar discharge display device is the three-electrode AC type planar discharge display device in which a plurality of electrode layers 104 formed on the respective top portions 103 of a plurality of grooves 102 of the glass substrate 101 are used as a plurality of address electrodes and XY matrixes are formed on the rear glass substrate 106 so as to become perpendicular to a plurality of address electrodes 104, a plurality of sustain electrodes 107, 108 disposed alternately and parallelly so as to become perpendicular to a plurality of address electrodes 104 to thereby form an XY matrix are formed on the rear glass substrate 106 and AC type discharge electrodes are formed by coating a plurality of sustain electrodes 107, 108 with the dielectric layer 109. FIG. 18 shows the state in which part of the dielectric layer 109 is left and the remaining portions are removed from the sustain electrodes.

The sustain electrodes 107 and 108 on the rear glass substrate 106 can be easily formed by burning conductive paste ink such as silver or nickel after it had been treated by screen printing. Similarly to the ordinary three-electrode type planar discharge display device, either the sustain electrodes 107 or 108 form the XY matrix with the opposing address electrodes 104, and the other sustain electrodes are commonly interconnected to each pixel and thereby used for sustain discharging.

The pair of these sustain electrodes 107 and 108 are the AC electrodes in which their surfaces are covered with the dielectric layer 109 and their surfaces are further covered with a protective layer such as magnesium oxide. A protective layer is not shown in FIG. 18.

On the other hand, in the front side of FIG. 18, there is illustrated the glass substrate 101 having the groove of the cross-section of V-like shape as the front glass substrate. The groove having the cross-section of U-like shape may be formed on this front glass substrate 101.

The surface of the electrode layer 104 serving as the address electrode can be coated with a dielectric layer so that the address electrode can be formed as the AC type electrode. Although display contrast of the planar discharge display device can be increased by making the electrode layer 104 become black, if color filters corresponding to colors of respective emitted light beams are formed on the grooves 102 by coating dyes of respective colors before the electrode layer 104 is formed, then contrast and color purity can be increased.

While FIG. 18 shows the three-electrode surface emission type planar discharge display device including the transmission type fluorescent screen in which the fluorescent screen is provided at the front side, if the front glass substrate 101 and the rear glass substrate 106 are replaced with each other and the electrodes 107 and 108 are formed of transparent electrodes, then it is possible to form a three-electrode surface emission type planar discharge display device including a reflection type fluorescent screen.

In the three-electrode surface emission type planar discharge display device including the transmission fluorescent screen to which the front glass substrate having the cross-section of V-like or U-like shape is applied, the sustain electrode on the rear glass substrate side executes sustain discharging and ultraviolet rays generated by such sustain discharging excite the fluorescent screens provided within the grooves of the front glass substrate to emit light beams. Emitted light beams are irradiated on the transparent glass portion between the respective grooves and most of light beams are reflected on the wall surface of the adjacent groove and irradiated onto the front side. Although the portion of the electrode which may operate as the address electrode on the top portion of the groove cannot pass light beams emitted from the fluorescent substance, as shown in FIG. 18, when the groove has the V-like cross-sectional shape, this portion has low luminous efficiency from the beginning and this portion can hardly affect brightness but can considerably increase contrast of the planar discharge display device. When the groove has the cross-section of U-like shape, since the pixel is relatively large, if the width of the electrode is decreased, then the groove having such cross-sectional shape can hardly affect brightness.

### LIST OF REFERENCE NUMERALS AND ITEMS

1 . . . the front glass substrate

2 . . . the groove

3 . . . the fluorescent substance

4 . . . the light absorption layer

5 . . . the light reflective layer

6 . . . the transparent conductive layer

7 . . . the metal film

11 . . . the groove depth

12 . . . the bottom opening portion and its width

13 . . . the gap between adjacent grooves and its width

14 . . . the top portion and its width

15 . . . the side wall of groove

16 . . . the inclination angle of side surface with respect to adjacent groove

21 . . . the rear glass substrate

22 . . . the dielectric layer

23 . . . the rib

24 . . . the fluorescent substance

25 . . . the dielectric layer

26 . . . the protective layer

27 . . . the address electrode

28 . . . the sustain electrode

29 . . . the sustain electrode

41 . . . the rear glass substrate

42 . . . the address electrode

43 . . . the insulating layer

44 . . . the sustain electrode

45 . . . the sustain electrode

46 . . . the through-hole

47 . . . the upper dielectric layer

52 . . . the first electrode

53 . . . the insulating layer

54 . . . the electrode

55 . . . the cathode layer

60 . . . the electron beam

101 . . . the glass substrate

102 . . . the first groove

103 . . . the top portion

104 . . . the electrode (address electrode)

105 . . . the fluorescent substance

106 . . . the rear glass substrate

107 . . . the first sustain electrode

108 . . . the second sustain electrode

109 . . . the dielectric layer

110 . . . the second groove

111 . . . the mask

1. A front glass substrate for a display tube characterized in that a plurality of grooves having similar cross-sections of approximately V-like shapes and which have approximately flat tops are formed on one surface side of a glass substrate in parallel to each other at a predetermined interval and fluorescent substance layers are deposited on said top portions and inner wall surfaces of said plurality of grooves.

2. In a front glass substrate for a display tube according to claim 1, a front glass substrate for a display tube characterized in that a width of said top portion is less than half of that of an opening portion, a height from said opening portion to said top portion is larger than the width of said opening portion and a gap width of opening portions of said adjacent grooves is smaller than half of the width of the opening portion of said groove in the cross-sections of said plurality of grooves.

3. A front glass substrate for a display tube according to claim 1 or 2, a front glass substrate for a display tube characterized in that said plurality of grooves have light absorption layers deposited on their top portions.

4. A front glass substrate for a display tube according to claim 1 or 2, a front glass substrate for a display tube characterized in that said plurality of grooves has a light reflective layer deposited at a gap between said adjacent opening portions thereof.

5. In a front glass substrate for a display tube according to claim 1 or 2, a front glass substrate for a display tube characterized in that said plurality of grooves have light absorption layers deposited on the top portions thereof and said plurality of grooves have a light reflective layer deposited at a gap between said adjacent opening portions thereof.

6. In a front glass substrate for a display tube according to claim 1 or 2, a front glass substrate for a display tube characterized by transparent conductive layers deposited on the lower layers of said fluorescent substance layers in said top portions and said inner wall portions of said plurality of grooves.

7. In a front glass substrate for a display tube according to claim 1 or 2, a front glass substrate for a display tube characterized in that said fluorescent substance layers have light reflective conductive layers deposited thereon.

8. A planar discharge display device comprising:
A front glass substrate for a display tube in which a plurality of grooves having similar cross-sections of approximately V-like shapes and which have approximately flat tops are formed on one surface side of a glass substrate in parallel to each other at a predetermined interval and fluorescent substance layers are deposited on said top portions and inner wall surfaces of said plurality of grooves; and
a rear glass substrate including address electrodes and sustain electrodes, wherein said front glass substrate and said rear glass substrate comprise a flat tube-assembly having gas filled therein.

9. In a planar discharge display device according to claim 8, a planar discharge display device characterized in that a width of said top portion is less than half of that of an opening portion, a height from said opening portion to said top portion is larger than the width of said opening portion and a gap width of opening portions of said adjacent grooves is smaller than half of the width of the opening portion of said groove in the cross-sections of said plurality of grooves.

10. In a planar discharge display device according to claim 8 or 9, a planar discharge display device characterized in that said plurality of grooves have light absorption layers deposited on their top portions.

11. In a planar discharge display device according to claim 8 or 9, a planar discharge display device characterized in that said plurality of grooves have a light reflective layer deposited at a gap between said adjacent opening portions thereof.

12. In a planar discharge display device according to claim 8 or 9, a planar discharge display device characterized in that said plurality of grooves have light absorption layers deposited on the top portions thereof and said plurality of grooves have a light reflective layer deposited at a gap between said adjacent opening portions thereof.

13. A low-speed electron beam type fluorescent display device comprising:
a front glass substrate in which a plurality of grooves having similar cross-sections of approximately V-like shapes and which have approximately flat tops are formed on one surface side of a glass substrate in parallel to each other at a predetermined interval, fluorescent substance layers are deposited on said top portions and inner wall surfaces of said plurality of grooves and transparent conductive layers to which an electron acceleration anode potential is applied are deposited on the lower layers of said fluorescent substance layers on said top portions and said inner wall portion of said plurality of grooves; and
a rear glass substrate having electrodes containing cathodes and pixel selection control gates deposited thereon, wherein said front glass substrate and said rear glass substrate comprise a flat tube-assembly.

14. In a low-speed electron beam type fluorescent display device according to claim 13, a low-speed electron beam type fluorescent display device characterized in that a width of said top portion is less than half of that of an opening portion, a height from said opening portion to said top portion is larger than the width of said opening portion and a gap width of opening portions of said adjacent grooves is smaller than half of the width of the opening portion of said groove in the cross-sections of said plurality of grooves.

15. A field radiation type fluorescent display device comprising:
a front glass substrate in which a plurality of grooves having similar cross-sections of approximately V-like shapes and which have approximately flat tops are formed on one surface side of a glass substrate in parallel to each other at a predetermined interval, fluorescent substance layers are deposited on said top portions and inner wall surfaces of said plurality of grooves and transparent conductive layers to which an electron acceleration anode potential is applied are deposited on the lower layers of said fluorescent substance layers on said top portions and said inner wall portion of said plurality of grooves; and
a rear glass substrate having electrodes containing cathodes and pixel selection control gates deposited thereon, wherein said front glass substrate and said rear glass substrate comprise a flat tube-assembly.

16. In a field radiation type fluorescent display device according to claim 15 a field emission type fluorescent display device characterized in that a width of said top portion is less than half of that of an opening portion, a height from said opening portion to said top portion is larger than the width of said opening portion and a gap width of opening portions of said adjacent grooves is smaller than half of the width of the opening portion of said groove in the cross-sections of said plurality of grooves.

17. A cathode-ray tube comprising:
a front glass substrate in which a plurality of grooves having similar cross-sections of approximately V-like shapes and which have approximately flat tops are formed on one surface side of a glass substrate in parallel to each other at a predetermined interval, fluorescent substance layers are deposited on said top portions and inner wall surfaces of said plurality of grooves and transparent conductive layers to which an electron acceleration anode potential is applied are deposited on the lower layers of said fluorescent substance layers on said top portions and said inner wall portion of said plurality of grooves; and
a rear glass substrate including an electron gun and an electron beam deflecting means, wherein said front glass substrate and said rear glass substrate comprise a flat tube-assembly.

18. In a cathode-ray tube according to claim 17, a cathode-ray tube characterized in that a width of said top portion is less than half of that of an opening portion, a height from said opening portion to said top portion is larger than the width of said opening portion and a gap width of opening portions of said adjacent grooves is smaller than half of the width of the opening portion of said groove in the cross-sections of said plurality of grooves.

19. A field radiation type fluorescent display apparatus comprising:
a front glass substrate in which a plurality of grooves having similar cross-sections of approximately V-like shapes and which have approximately flat tops are formed on one surface side of a glass substrate in parallel to each other at a predetermined interval, fluorescent substance layers are deposited on said top portions and inner wall surfaces of said plurality of grooves and transparent conductive layers to which an electron acceleration anode potential is applied are deposited on the lower layers of said fluorescent substance layers on said top portions and said inner wall portion of said plurality of grooves; and
a rear glass substrate including an electron gun and an electron beam deflecting means, wherein said front glass substrate and said rear glass substrate comprise a flat tube-assembly.

20. In a field radiation type fluorescent display device according to claim 19, wherein a width of said top portion is less than half of that of an opening portion, a height from said opening portion to said top portion is larger than the width of said opening portion and a gap width of opening portions of said adjacent grooves is smaller than half of the width of the opening portion of said groove in the cross-sections of said plurality of grooves.

21. A discharge luminescent device for illumination comprising:
a front glass substrate in which a plurality of grooves having similar cross-sections of approximately V-like shapes and which have approximately flat tops are formed on one surface side of a glass substrate in parallel to each other at a predetermined interval, fluorescent substance layers are deposited on said top portions and inner wall surfaces of said plurality of grooves and transparent conductive layers to which an electron acceleration anode potential is applied are deposited on the lower layers of said fluorescent substance layers on said top portions and said inner wall portion of said plurality of grooves; and
a rear glass substrate including a pair of coil-like hot cathodes positioned at respective ends of said plurality of grooves, wherein said front glass substrate and said rear glass substrate comprise a tube-assembly.

22. In a discharge luminescent device for illumination according to claim 21, wherein a width of said top portion is less than half of that of an opening portion, a height from said opening portion to said top portion is larger than the width of said opening portion and a gap width of opening portions of said adjacent grooves is smaller than half of the width of the opening portion of said groove in the cross-sections of said plurality of grooves.

23. A glass substrate for a planar discharge display device characterized in that a plurality of grooves having similar cross-sections of approximately V-like shapes and which have approximately flat tops are formed on one surface side of a glass substrate in parallel to each other at a predetermined interval, electrode layers are deposited on top portions of said plurality of grooves and fluorescent substance layers are deposited on said top portions and inner wall surfaces of said plurality of grooves.

24. A method of forming electrodes of a glass substrate for a planar discharge display device comprising the steps of:
forming reservoirs of a paste-like conductive ink on top portions of a plurality of grooves by coating said paste-like conductive ink on a plurality of grooves having same cross-sections V-like shapes formed on one surface side of a glass substrate at a constant interval in parallel to each other;
drying said paste-like conductive ink within said plurality of grooves;
removing said conductive ink from the inner wall surfaces of said plurality of groves by sandblasting said glass substrate;
leaving stripe-like conductive inks on the top portions of said plurality of grooves; and
forming electrodes by sintering said remaining stripe-like conductive inks.

25. A glass substrate for a planar discharge display device characterized in that a plurality of first grooves having same cross-sections of U-like shapes are formed on one surface side of a glass substrate at a constant interval in parallel to each other, second grooves are formed on respective top portions of said plurality of first grooves, electrode layers are respectively deposited to the insides of said plurality of second grooves and fluorescent substance layers are deposited on the inner wall surfaces of said plurality of second grooves and said electrode layers.

26. A method of forming electrodes for a planar discharge display device comprising the steps of:
masking portions except top portions of a plurality of first grooves including same cross-sections of substantially U-like shapes formed on one surface side of a glass substrate at a constant interval in parallel to each other by a mask;
forming second grooves on respective top portions of said plurality of first grooves through said mask by sandblast or chemical etching;
forming reservoirs of paste-like conductive ink in the insides of said plurality of second grooves by coating said paste-like conductive ink over the insides of said plurality of first grooves and the insides of said second grooves of respective top portions of said plurality of first grooves;
drying said conductive ink within said plurality of first grooves and within said second grooves of respective top portions of said plurality of first grooves;
removing said conductive ink from the inner wall surfaces of said plurality of grooves by sandblasting said glass substrate;
leaving stripe-like conductive inks on said plurality of second grooves; and
forming electrodes by sintering said remaining stripe-like conductive inks.

27. A planar discharge display device comprising:
a front glass substrate in which a plurality of grooves having same cross-sections of substantially V-like shapes formed on one surface side of a glass substrate at a constant interval in parallel to each other, electrode layers are deposited on top portions of said plurality of grooves as address electrodes and fluorescent substance layers are deposited on the inner wall surfaces of said plurality of grooves and said electrode layers; and
a rear glass substrate including an AC type discharge electrode comprised of a pair of parallel sustain electrodes perpendicular to said plurality of address electrodes to comprise an XY matrix and a dielectric layer for covering said pair of sustain electrodes, wherein said front glass substrate and said rear glass substrate constitute a flat tube-assembly having gas filled therein.

28. A planar discharge display device comprising:
a front glass substrate in which a plurality of grooves having same cross-sections of substantially U-like shapes are formed on one surface side of a glass substrate at a constant interval in parallel to each other, second grooves are formed on respective tops of said plurality of first grooves, electrode layers are respectively deposited within said plurality of second grooves as address electrodes and fluorescent substance layers are deposited on the inner wall surfaces of said plurality of first grooves and said electrode layers; and
a rear glass substrate including an AC type discharge electrode comprised of a pair of parallel sustain electrodes perpendicular to said plurality of address electrodes to comprise an XY matrix and a dielectric layer for covering said pair of sustain electrodes, wherein said front glass substrate and said rear glass substrate constitute a flat tube-assembly having gas filled therein.

29. A discharge light-emitting device for illumination comprising:
a front glass substrate in which a plurality of grooves having same cross-sections of substantially V-like shape and which has substantially flat top portions are formed on one surface side of a glass substrate at a constant interval in parallel to each other and in which fluorescent substance layers are deposited on the top portions of said plurality of grooves and inner wall surfaces; and
a rear glass substrate including a pair of AC type discharge electrodes located at respective ends of said plurality of grooves, wherein said front glass substrate and said rear glass substrate constitute a tube-assembly.

30. In a discharge light-emitting device for illumination according to claim 29, a discharge light-emitting device for illumination characterized in that, in cross-sections of said plurality of grooves, the width of said top portion is made less than half of a width of the opening portion, a height from said opening portion to said top portion is made larger than the width of said opening portion and a gap width between opening portions of said adjacent grooves is made smaller than half of the width of the opening portion of said groove.
